(19) United States
(12) Patent Application Publication
(10) Pub. No.: US 2011/0225750 A1
(43) Pub. Date: Sep. 22, 2011

(54) ADJUSTABLE CLEANING ASSEMBLIES HAVING NECK-CONNECTING DEVICES

(75) Inventor: Kai Hirsch, Cologne (DE)

(73) Assignee: Unger Marketing International, LLC, Bridgeport, CT (US)

(21) Appl. No.: 13/045,995

(22) Filed: Mar. 11, 2011

Related U.S. Application Data
(60) Provisional application No. 61/314,339, filed on Mar. 16, 2010.

(51) Int. Cl. B08B 1/00

(52) U.S. Cl. 15/104.94

(57) ABSTRACT

A cleaning assembly is provided that includes a pole, a cleaning tool, an neck-connecting device, and an axial-rotational adjusting member. The pole has a first threaded end and the cleaning tool has a second threaded end. The neck-connecting device connects the pole and the tool to one another. The axial-rotational adjusting member adjusts a rotational position of the tool about an axis of the neck-connecting device. A window cleaning assembly kit is also provided. The kit includes an angled neck-connecting device and a least one adapter configured to interconnect the angled neck-connecting device to a cleaning tools and/or a pole.

### CROSS REFERENCE TO RELATED APPLICATIONS

This application claims the benefit of U.S. Provisional Application Ser. No. 61/314,339, filed Mar. 16, 2010 the contents of which are incorporated by reference herein.

### BACKGROUND OF THE INVENTION

1. Field of the Invention

The present disclosure is related to cleaning assemblies. More particularly, the present disclosure is related to cleaning assemblies having a pole, a cleaning tool, and a neck-connecting device, which secures the tool and the pole in an adjustable manner.

2. Description of Related Art

The access to windows and other surfaces in buildings having a height up to about seven stories for purposes of cleaning those windows can present a unique problem. These buildings are typically too small for window cleaning methods where the person cleaning the window is suspended from the top of the building and lowered to the windows. In addition, these buildings are typically too large for window cleaning methods where the person cleaning the window uses a ladder or other structure to climb up to the windows.

It has therefore become common to use a pole cleaning method for cleaning such windows where such pole cleaning methods are both less expensive and safer than the aforementioned methods.

In pole cleaning methods, a window cleaning assembly is used, where the cleaning assembly includes a pole with a cleaning tool attached to the upper end of the pole. The pole can be a telescoping pole or a segmented pole, which are configured to extend to a desired height, such as from as short as few feet to as high as about 60 or more feet. The cleaning tool can include devices such as, but not limited to, a brush, a sponge, a wiper blade, a scraper, dusters, scrubbers, and any combinations thereof (hereinafter “cleaning tool”).

Tap water, pure water, which is defined herein as water having total dissolved solids of less than 10 parts per million, de-ionized water, and/or cleaning fluids or detergents (hereinafter “water”) is fed to the top of the pole, either exterior to the pole or through the interior of the pole, to the cleaning tool for cleaning the windows. In this manner, the pole can then be used to move the cleaning tool against the window, while supplying the water to the cleaning tool, to clean and rinse the window.

Unfortunately, it has been determined by the present disclosure that the prior art cleaning tools have not been attached to the prior art poles in a manner that allows the tool to be adjusted to many desired positions, such as being properly aligned for use on the window. Further, the prior art cleaning tools have not been attached to the prior art poles in a manner that allowed for all the desired adjustments of the position of the cleaning tool with respect to the pole.

Accordingly, there is a continuing desire for cleaning assemblies that overcome, mitigate and/or alleviate one or more of the above described and other deleterious effects of the prior art assemblies.

### BRIEF SUMMARY OF THE INVENTION

A cleaning assembly is provided that includes a pole, a cleaning tool, an neck-connecting device, and an axial-rotational adjusting member. The pole has a first connecting member and the cleaning tool has a second connecting member. The neck-connecting device connects the pole and the tool to one another with set axial orientations. The axial-rotational adjusting member adjusts a rotational position of the tool about an axis of the neck-connecting device.

A cleaning assembly is also provided that includes a pole, a cleaning tool, an angled neck-connecting device, and an axial-rotational adjusting member. The pole has a first connecting member and the cleaning tool has a second connecting member. The angled neck-connecting device has a third connecting member and a fourth connecting member. The third connecting member engages with one of the first or the second connecting member, while the fourth connecting member engages with the other of the first or second connecting member so that the angled neck-connecting device removably secures the pole and the cleaning tool to one another with set axial orientations. The angled neck-connecting device includes a first arm having a first axis that is at an angle with respect to a second arm, which has a second axis. The axial-rotational adjusting member adjusts a rotational position of a first portion of the second arm with respect to a second portion of the second arm about the second axis.

In some embodiments, the axial-rotational adjusting member can include a tightening nut, the first portion, and the second portion. The tightening nut has an opening and a threaded area. The first portion has a first sealing surface and a retaining rim, where the retaining rim has a larger outer dimension than opening. The second portion has a second sealing surface and a threaded lip. The tightening nut is over the first portion so that the first portion is received in the opening with the retaining rim retaining the nut on the first portion. The first portion is on the second portion so that first and second sealing surfaces contact one another. The threaded area is threadably secured to the threaded lip.

The threaded area can be threadably secured to the threaded lip so that the first and second sealing surfaces are compressed against one another to prevent rotation of the first and second portions with respect to one another about second axis. Alternately, the threaded area can be threadably unsecured from the threaded lip as to allow the first and second portions to rotate with respect to one another about the second axis.

A cleaning assembly kit is also provided. The kit includes an angled neck-connecting device and a least one adapter configured to threadably interconnect the angled neck-connecting device to a cleaning tool and/or a pole. In some embodiments, the angled neck-connecting device includes a first arm having a first axis, a second arm having a second axis, and an axial-rotational adjusting member. The first arm is at an angle with respect to the second arm. The axial-rotational adjusting member allows selective adjustment of a rotational position of a first portion of the second arm with respect to a second portion of the second arm about the second axis.

The above-described and other features and advantages of the present disclosure will be appreciated and understood by those skilled in the art from the following detailed description, drawings, and appended claims.

### BRIEF DESCRIPTION OF THE SEVERAL VIEWS OF THE DRAWINGS

FIG. 1 is a perspective view of an exemplary embodiment of a cleaning assembly according to the present disclosure during use;

FIG. 2 is a partially exploded view of the cleaning assembly of FIG. 1;

FIG. 3 is a perspective view of an exemplary embodiment of a neck-connecting device according to the present disclosure;

FIG. 4 is an exploded view of the neck-connecting device of FIG. 3;

FIG. 5 is a sectional view of a portion of the neck-connecting device taken along lines 5-5 in FIG. 3; and

FIG. 6 is a sectional view of the portion of the neck-connecting device taken along lines 6-6 in FIG. 4.

### DETAILED DESCRIPTION OF THE INVENTION

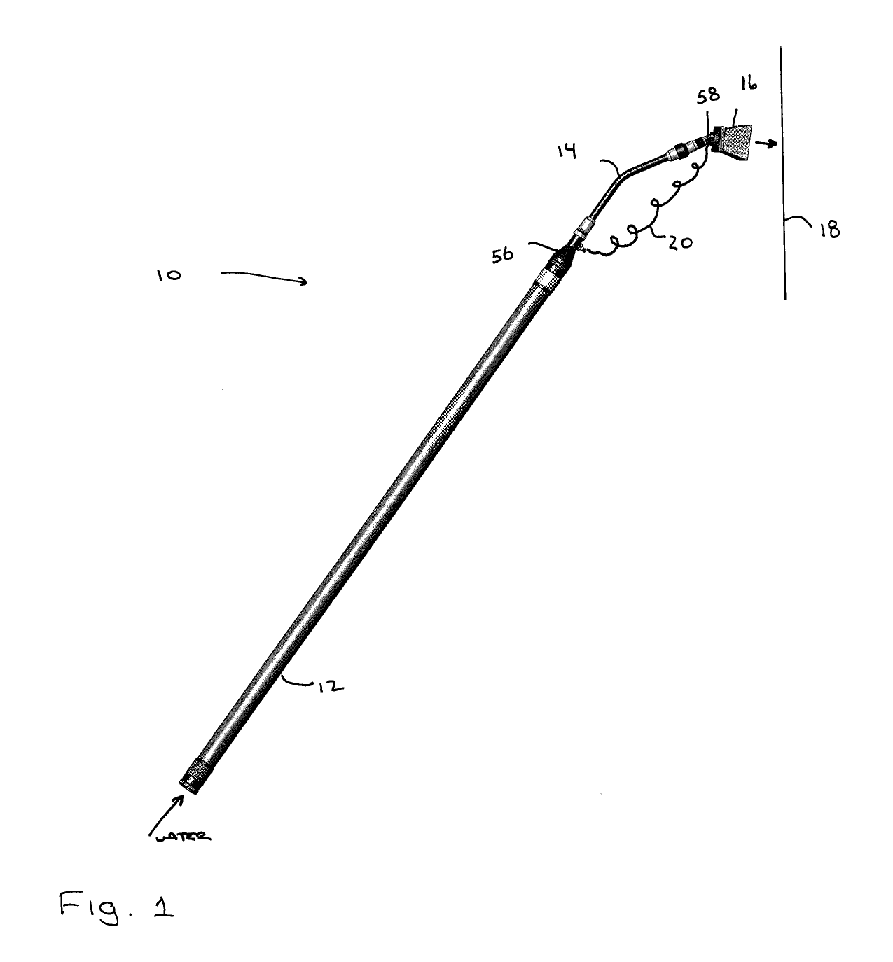

Referring to the drawings and in particular to FIG. 1, an exemplary embodiment of a cleaning assembly according to the present disclosure is shown and is generally referred to by reference numeral 10. Cleaning assembly 10 includes a pole 12, an neck-connecting device 14, and a cleaning tool 16. Advantageously, neck-connecting device 14 secures pole 12 and cleaning tool 16 in an adjustable manner so that the tool can be correctly aligned with a surface to be cleaned 18. Surface 18 can be any desired commercial or residential surface such as, but not limited, to a window, a building, a vehicle, a building interior, a building exterior, an awning, a shutter, a fire escape, a solar panel, a sign, siding, a traffic light, or any other a surface that may become soiled and require cleaning.

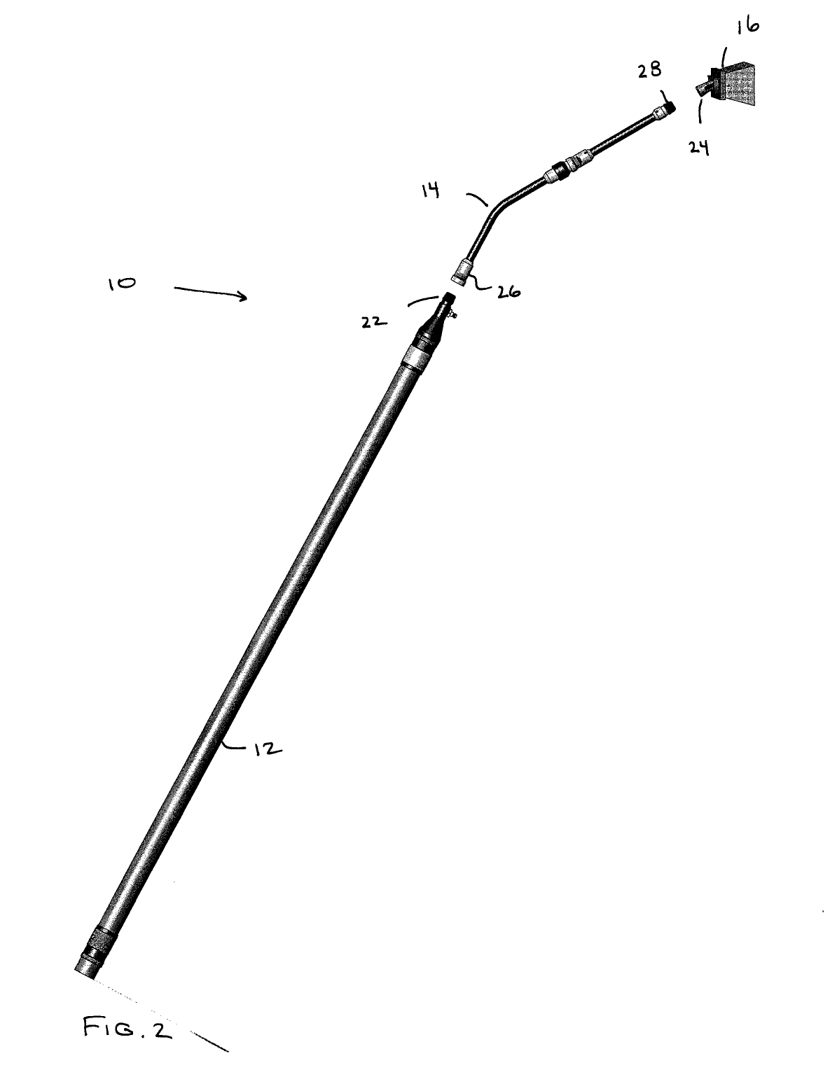

Pole 12 can be a sectional pole as shown in FIGS. 1 and 2 such as, but not limited to, the HIFLO™ CARBONTEC™ pole system that is commercially available from the assignee of the present application and is described in detail in the assignee's pending U.S. application Ser. No. 11/873,702, the contents of which are incorporated herein in their entirety.

Alternately, pole 12 can be a telescoping extension pole such as, but not limited to, the HIFLOW™ Advanced extension pole that is also commercially available from the assignee of the present application. Of course, it is contemplated by the present disclosure for pole 12 to have any desired configuration.

Pole 12 can be a waterfed pole, in which the water is fed to cleaning tool 16 through a conduit defined within an interior of the pole as in FIG. 1. Alternately, pole 12 can be configured so that water is fed to cleaning tool 16 through a hose (not shown) along an exterior of the pole. Of course, it is contemplated by the present disclosure for pole 12 to have any desired configuration for supplying water from the ground level to cleaning tool 16. In addition, it is contemplated by the present disclosure for pole 12 to have any desired configuration where no water is required such as, but not limited to, painting poles, bulb changing poles, dusting poles, and standard telescopic poles for classic cleaning applications.

In some embodiments, cleaning assembly 10 can further include a conduit 20 for supplying water from pole 12 to cleaning tool 16. More specifically, conduit 20 places pole 12 in fluid communication with cleaning tool 16. Conduit 20 is, preferably, exterior to neck-connecting device 14.

Cleaning tool 16 can be any tool for cleaning surface 18. For example, cleaning tool 16 can be a brush, a squeegee, a mop, a wiping device, a sponge, a clamp for holding a dusting cloth or a sponge, a combination device having, for example a squeegee and a scrubber, a feather duster, a wool duster, a flex duster, a microfiber duster, or any other desired device. Cleaning tool 16 is, preferably, a water fed brush as shown in FIGS. 1 and 2, where water from pole 12 is fed directly through the bristles of the brush.

Referring to FIG. 2, pole 12 includes a first connecting member 22 and cleaning tool 16 includes a second connecting member 24. First and second connecting members 22, 24 are described herein by way of example as being threaded members such as male threaded members, female threaded members, or any combinations thereof.

Similarly, neck-connecting device 14 includes a third connecting member 26 at one end and a fourth connecting member 28 at the opposite end. Third connecting member 26 is configured to engage with first connecting member 22, while fourth connecting member 28 is configured to engage with second connecting member 24. Third and fourth connecting members 26, 28 are also described herein by way of example as being threaded members such as male threaded members, female threaded members, or any combinations thereof. In this manner, neck-connecting device 14 threadably and removably secures pole 12 and cleaning tool 16 to one another.

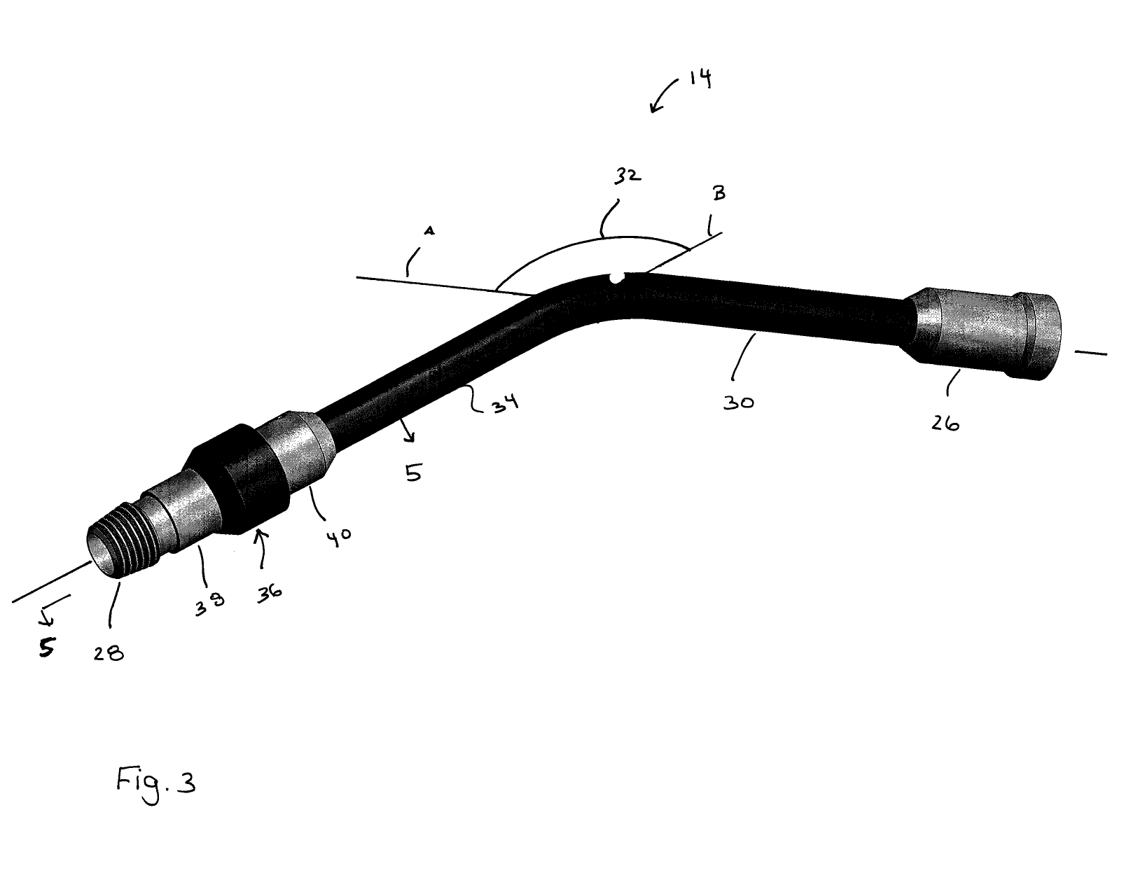

As shown in FIG. 3, neck-connecting device 14 includes a first arm 30 at an angle 32 with respect to a second arm 34. More specifically, first arm 30 has a first axis A, while second arm 34 has a second axis B. In some embodiments, first axis A and second axis B are common to one another such that neck-connecting device 14 is a straight connector with angle 32 being 180 degrees.

In other embodiments, such as that shown in FIG. 3, neck-connecting device 14 is angled, with a set or non-adjustable angle 32 of first axis A with respect to second axis B being greater than 0 degrees but less than 180 degrees, more preferably with angle 32 being between about 90 degrees to about 170 degrees, with between about 120 degrees to about 150 degrees being most preferred, and any subranges therebetween.

In still other embodiments, neck-connecting device 14 is angled, with an adjustable angle 32 of first axis A with respect to second axis B. For example, angle 32 can be modified and/or changed depending on the type of cleaning tool 16 and/or pole 12 that are connected to the neck-connecting device 14, as well as the angle of the configuration of cleaning surface 18, and the flex of the pole, which can be important when used at high heights, and the most effective angle of the cleaning tool 16 to surface 18 being cleaned. For example, neck-connecting device 14 can include an angle adjuster (not shown) configured to selectively adjust angle 32 of first axis A with respect to second axis B.

In the illustrated embodiment, neck-connecting device 14 is formed having first and second arms 30, 34 made of a single unitary member that is bent to a single angle 32. However, it is contemplated by the present disclosure for neck-connecting device 14 to be formed having first and second arms 30, 34 made of separate members that are joined to one another in a rigidly or selectively adjustably manner to provide angle 32.

When threadably connecting second connecting member 24 of cleaning tool 16 to fourth connecting member 28 of neck-connecting device 14, the cleaning tool is rotated about second axis B until the cleaning tool is sufficiently secured to the neck-connecting device. Unfortunately, it has been determined by the present disclosure that this rotation about second axis B can result in cleaning tool 16 being misagligned with respect to a desired position on surface 18. Stated another way, the threaded connection of first/third connecting members 22, 26 and second/fourth connecting members 24, 28 provides tool 16 with a set axial orientation about second axis B and pole 12 with a set axial orientation about first axis A, where these set axial orientations are determined by the threaded connections and not by the desired axial orientation of the tool or pole.

Advantageously, neck-connecting device 14 includes an axial-rotational adjusting member 36, which is configured to selectively adjust a rotational position of a first portion 38 of second arm 34 with respect to a second portion 40 of the second arm about second axis B. In this manner, the position of cleaning tool 16, which is connected to second portion 38, can be adjusted about the second axis B to a desired position after the cleaning tool has been threadably connected to the second portion.

Cleaning assembly 10 is described above by way of example only as having neck-connecting device 14 threadably and removably securing pole 12 and cleaning tool 16 to one another for purposes of describing the aforementioned problem regarding the set axial orientation of the cleaning tool about second axis B. However, it is contemplated by the present disclosure for cleaning assembly 10 to have any desired connecting mechanism between pole 12 and neck-connecting device 14, as well as between the neck-connecting device and tool 16.

Thus, it is contemplated by the present disclosure for connecting members 22,26 and 24,28 to be any complimentary connecting members providing a set axial orientation about the first and second axes A, B. For example, connecting members 22,26 and 24,28 can include a locking cone such as, but not limited to, the cone described in commonly owned and assigned U.S. Pat. No. 7,413,366, the contents of which are incorporated by reference herein.

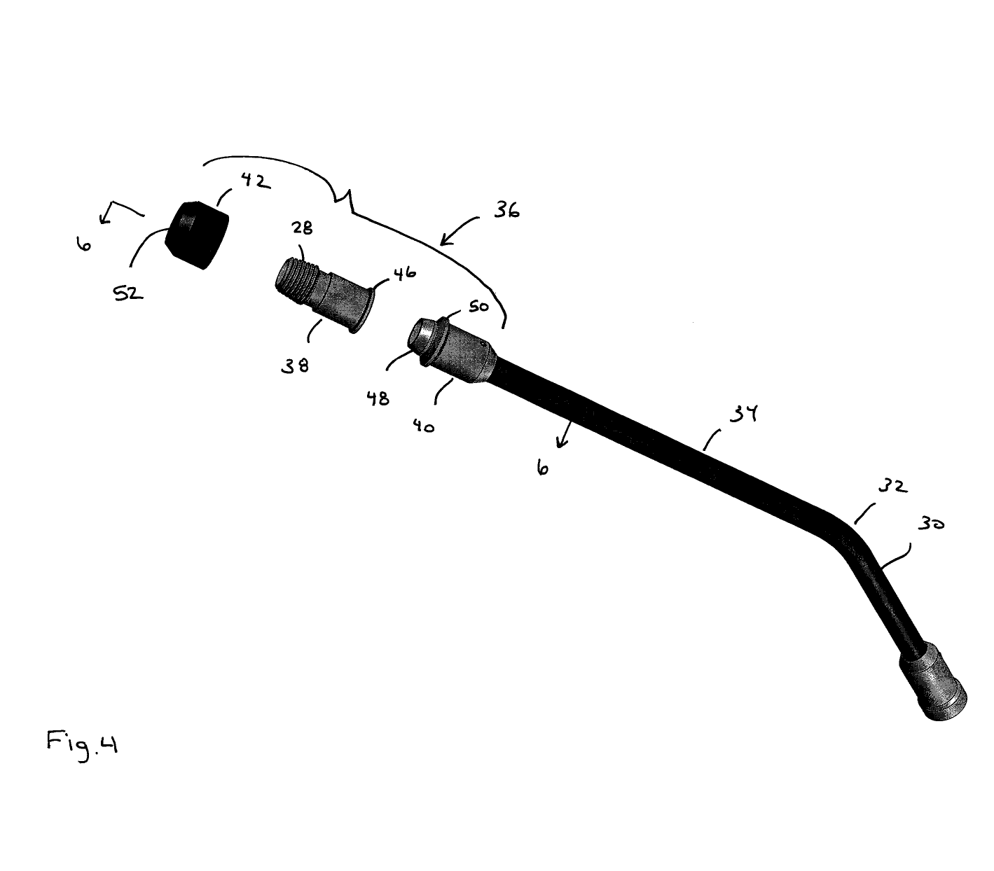

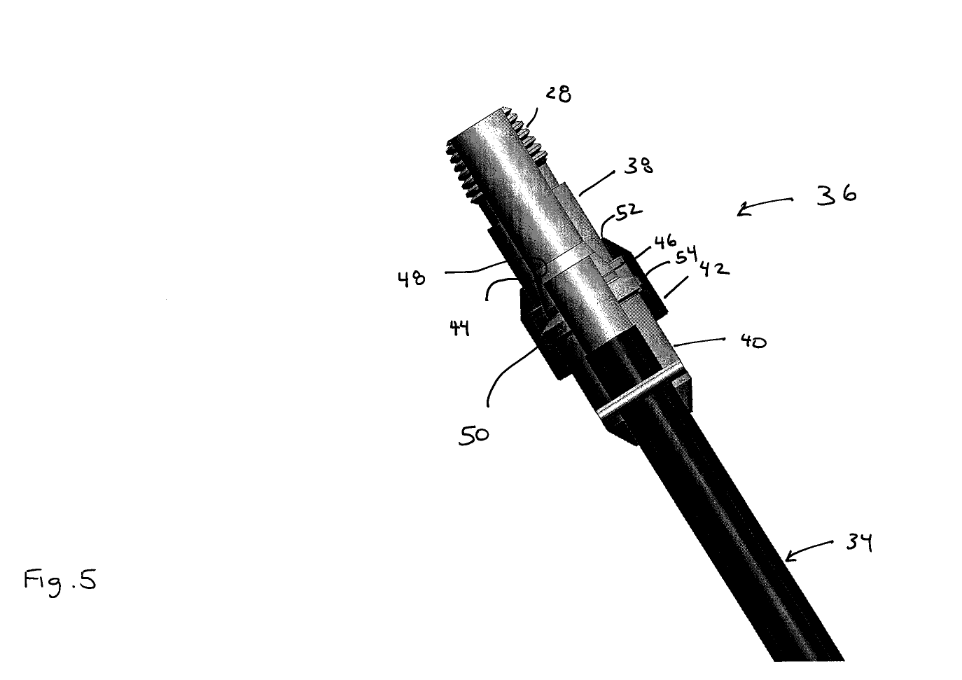

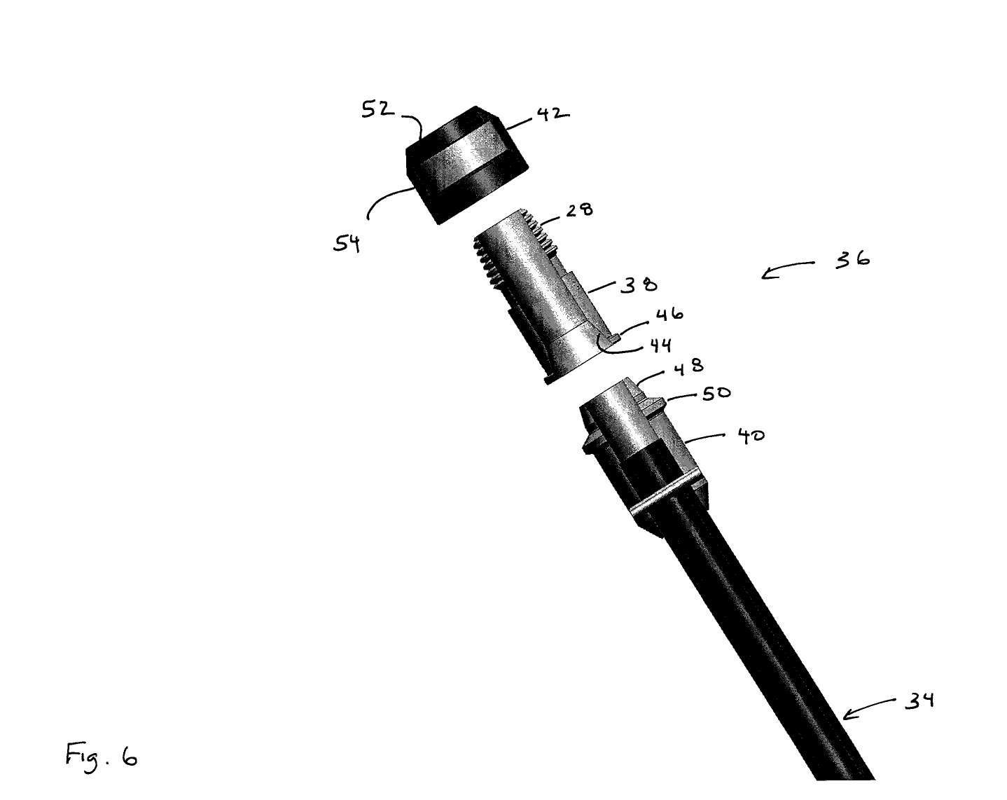

Rotational adjusting member 36 is described with simultaneous reference to FIGS. 4 through 6. Axial-rotational adjusting member 36 includes first portion 38, second portion 40, and a tightening nut 42.

First portion 38 includes a first sealing surface 44 and a retaining rim 46. Second portion 40 includes a second sealing surface 48 and a threaded lip 50. Tightening nut 42 includes an opening 52 and a threaded area 54. Retaining rim 46 has a larger outer dimension than the dimension of opening 52.

In use, tightening nut 42 is slideably and rotationally disposed over first portion 38 so that the first portion is received in opening 52 with retaining rim 46 retaining the nut on the first portion. First portion 38 is positioned on second portion 40 so that first and second sealing surfaces 44, 48 contact one another.

Threaded area 54 can be threadably secured to threaded lip 50 so that first and second sealing surfaces 44, 48 are compressed against one another to prevent rotation of first and second portions 38, 40 with respect to one another about second axis B. Alternately, threaded area 54 can be loosened from threaded lip 50 so as to allow first and second portions 38, 40 to rotate with respect to one another about second axis B. Sealing surfaces 44, 48 are preferably smooth surfaces. However, it is contemplated by the present disclosure for surfaces 44, 48 to have a texture to increase the coefficient of friction therebetween and/or to have mating grooves that lock into each other at small increments to allow the adjustablitity of the angle about first and/or second axes A, B.

In this manner, cleaning assembly 10 advantageously allows for the connection of various commercially available cleaning tools 16 to various commercially available poles 12 using neck-connecting device 14 and allows the position of the cleaning tool to adjusted after securement to the neck-connecting device.

In some embodiments, cleaning assembly 10 can include one or more adapters 56, 58 configured to interconnect neck-connecting device 14 to cleaning tools 16 and/or poles 12.

In other embodiments, cleaning assembly 10 may be sold in one or more kits of components that include neck-connecting device 14, and one or more adapters 56, 58.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A cleaning assembly comprising:
a pole having a first connecting member;
a cleaning tool having a second connecting member;
a neck-connecting device connecting said pole and said tool to one another with a set axial orientation; and
an axial-rotational adjusting member on said neck-connecting device, said axial-rotational adjusting member being configured to adjust a rotational position of said tool about an axis of said neck-connecting device.

2. The cleaning assembly of claim 1, wherein said neck connecting device is an angled neck-connecting device including a first arm at an angle with respect to a second arm, said first arm having a first axis and second arm having a second axis.

3. The cleaning assembly of claim 2, wherein said first and second arms are separate members rigidly joined to one another.

4. The cleaning assembly of claim 2, wherein said first and second arms are separate members adjustably joined to one another.

5. The cleaning assembly of claim 2, wherein said angle is greater than 0 degrees but less than 180 degrees.

6. The cleaning assembly of claim 2, wherein said angle is between 120 degrees to 150 degrees.

7. The cleaning assembly of claim 2, wherein said first and second arms are formed of a single unitary member that is bent to said angle.

8. The cleaning assembly of claim 1, wherein said first and second connecting members are threaded ends.

9. A cleaning assembly comprising:
a pole having a first connecting member;
a cleaning tool having a second connecting member; and
an angled neck-connecting device having a third connecting member and a fourth connecting member, said third connecting member being engagable with one of said first or second connecting members, said fourth connecting member being engagable with another of said first or second connecting members so that said angled neck-connecting device removably secures said pole and said cleaning tool to one another with set axial orientations, said angled neck-connecting device including a first arm at an angle with respect to a second arm, the first arm having a first axis and second arm having a second axis; and
an axial-rotational adjusting member configured to adjust a rotational position of a first portion of said second arm with respect to a second portion of said second arm about said second axis.

10. The cleaning assembly of claim 9, wherein said axial-rotational adjusting member further comprises a tightening nut having an opening and a threaded area, said first portion having a first sealing surface and a retaining rim, said retaining rim having a larger outer dimension than said opening, and wherein said second portion has a second sealing surface and a threaded lip, said tightening nut being disposed over said first portion so that said first portion is received in said opening with said retaining rim retaining said tightening nut, said first portion being positioned on said second portion so that said first and second sealing surfaces contact one another, and said threaded area being threadably securable to said threaded lip.

11. The cleaning assembly of claim 12, wherein said threaded area is threadably securable to said threaded lip so that said first and second sealing surfaces are compressed against one another to prevent rotation of said first and second portions with respect to one another about said second axis.

12. The cleaning assembly of claim 12, wherein said threaded area is threadably unsecurable from said threaded lip as to allow said first and second portions to rotate with respect to one another about said second axis.

13. A cleaning assembly kit, comprising:
an angled neck-connecting device; and
a least one adapter configured to interconnect said angled neck-connecting device to a cleaning tool and/or a pole, wherein said angled neck-connecting device comprises:
a first arm having a first axis;
a second arm having a second axis, said first arm being at an angle with respect to said second arm; and
an axial-rotational adjusting member being configured to adjust a rotational position of a first portion of said second arm with respect to a second portion of said second arm about said second axis.

14. The cleaning assembly kit of claim 14, wherein said axial-rotational adjusting member further comprises a tightening nut having an opening and a threaded area, said first portion having a first sealing surface and a retaining rim, said retaining rim having a larger outer dimension than said opening, and said second portion having a second sealing surface and a threaded lip, said tightening nut being slideably and rotationally disposed over said first portion so that said first portion is received in said opening with said retaining rim retaining said tightening nut on said first portion, said first portion being positioned on said second portion so that said first and second sealing surfaces contact one another, and said threaded area being threadably securable to said threaded lip.

15. The cleaning assembly kit of claim 14, wherein said threaded area is threadably securable to said threaded lip so that said first and second sealing surfaces are compressed against one another to prevent rotation of said first and second portions with respect to one another about said second axis, and
wherein said threaded area is threadably unsecurable from said threaded lip as to allow said first and second portions to rotate with respect to one another about said second axis.
